(19) United States
(12) Patent Application Publication
(10) Pub. No.: US 2015/0362293 A1
(43) Pub. Date: Dec. 17, 2015

(54) CERAMIC MEMBER ENCASED IN COMPOSITE LAYER

(71) Applicant: ANGEL ARMOR, LLC, Fort Collins, CO (US)

(72) Inventor: Eric B. Strauss, Fort Collins, CO (US)

(21) Appl. No.: 14/741,400

(22) Filed: Jun. 16, 2015

Related U.S. Application Data
(63) Continuation-in-part of application No. 14/539,259, filed on Nov. 12, 2014.
(60) Provisional application No. 62/012,959, filed on Jun. 16, 2014.
(60) Provisional application No. 61/903,353, filed on Nov. 12, 2013.

(51) Int. Cl. F41H 5/04; B32B 38/00; B32B 37/14; B32B 37/10; B32B 5/26; B32B 18/00

(52) U.S. Cl. CPC F41H 5/0414; B32B 5/26; B32B 18/00; F41H 5/0435; B32B 37/142; B32B 37/1009; B32B 38/0036; B32B 2255/02; B32B 2255/26; B32B 2307/558; B32B 2307/56; B32B 2571/02; B32B 2038/0076; B32B 2313/04; B32B 2398/20

(57) ABSTRACT

A ballistic resistant apparatus can include a composite layer encasing a ceramic member. The composite layer can include a reinforcing material, such as a woven carbon fiber fabric. The reinforcing material can be impregnated with the matrix material, such as a thermoset resin, which can be cured inside a vacuum bag to form a hard shell that encases the ceramic member and provides a compressive force against an outer surface of the ceramic member. The ballistic resistant apparatus exhibits excellent durability and ballistic performance and is capable of withstanding impacts from multiple rounds of ammunition. In some examples, a plurality of ballistic resistant apparatuses can be arranged in an array and encased by a composite layer to form an array of ballistic resistant apparatuses that can have complex contours or geometries for use in protecting vehicles or dwellings from ballistic threats.

### CROSS-REFERENCE TO RELATED APPLICATIONS

This application claims the benefit of U.S. Provisional Patent Application No. 62/012,959 filed Jun. 16, 2014, and is a continuation-in-part of U.S. patent application Ser. No. 14/539,259 filed on Nov. 12, 2014, which claims the benefit of U.S. Provisional Patent Application No. 61/903,353 filed on Nov. 12, 2013, each of which is incorporated by reference herein as if fully set forth in this description.

### FIELD

This disclosure relates to ballistic resistant apparatuses and methods for manufacturing ballistic resistant apparatuses.

### BACKGROUND

Body armor is worn by police officers and military personnel to protect against ballistic threats. A carrier vest 100 containing ballistic resistant inserts, as shown in FIG. 1, is an example of body armor commonly worn by military personnel. Body armor often contains soft armor 200 made of flexible ballistic sheets that are constructed of high-performance fibers, such as KEVLAR or SPECTRA fibers. The ballistic sheets are commonly arranged in a stack, as shown in FIG. 2, and stitched together to prevent individual sheets from shifting during use. Shifting of individual sheets is undesirable, since it can degrade the soft armor's ballistic performance near the stack's perimeter. Soft armor 200 is often designed to protect against a round of ammunition from a small caliber handgun, such as a 9 mm pistol. To protect against greater ballistic threats, such as a round from an AK-47 rifle, the body armor can be upgraded to include hard armor, which can consist of a ceramic plate as shown in FIG. 3. These ceramic plates are known as ceramic trauma plates or, alternatively, as Small Arms Protective Inserts (SAPI) 300, and are inserted into a pocket in a carrier vest 100 to protect a wearer's chest 105, back 110, or sides 115 from ballistic threats.

### SUMMARY

This disclosure relates to ballistic resistant apparatuses containing a ceramic member encased in a composite layer and methods for manufacturing ballistic resistant apparatuses containing a ceramic member encased in a composite layer.

In one example, a ballistic resistant apparatus can include a ceramic member defined by an outer surface. The ballistic resistant apparatus can include a composite layer adjacent to the outer surface of the ceramic member. The composite layer can encase the ceramic member and provide a compressive force against the outer surface of the ceramic member. The composite layer can include a reinforcing layer impregnated with a matrix material. The composite layer can serve as a durable, protective shell that encases the ceramic member. The reinforcing layer can include a woven or nonwoven fabric made of carbon, glass, aramid, para-aramid, meta-aramid, polyolefin, or thermoplastic polyethylene fibers. The matrix material can include a thermoset resin made of epoxy resin, vinyl-ester resin, or polyester resin. The reinforcing layer can include a first sheet of reinforcing fabric and a second sheet of reinforcing fabric. The first sheet of reinforcing fabric can be wrapped around the outer surface of the ceramic member. The second sheet of reinforcing fabric can be wrapped around an outer surface of the first sheet of reinforcing fiber. The ceramic member can include silicon carbide, boron carbide, titanium carbide, tungsten carbide, zirconia toughened alumina, or high-density aluminum oxide.

The ballistic resistant apparatus can include a film adhesive layer positioned between the outer surface of the ceramic member and an inner surface of the composite layer. The film adhesive layer can and the inner surface of the composite layer to the outer surface of the ceramic member. The film adhesive layer can include polyethylene, polypropylene, ethylene, copolyester, copolyamide, or thermoplastic polyurethane. The film adhesive layer can be formed by flat film extrusion, blown film extrusion, or slit film extrusion process.

The ballistic resistant apparatus can include a stack of two or more ballistic sheets positioned between the outer surface of the ceramic member and the inner surface of the composite layer. The ballistic resistant apparatus can include a waterproof protective cover encasing the composite layer.

In another example, a method of manufacturing a ballistic resistant apparatus can include providing a ceramic member defined by an outer surface and wrapping a first sheet of preimpregnated carbon fiber fabric around the outer surface of the ceramic member. The method can include wrapping a second sheet of preimpregnated carbon fiber fabric around an outer surface of the first sheet of preimpregnated carbon fiber fabric. The first and second sheets of preimpregnated carbon fiber fabric can be impregnated with a resin that is uncured. The method can include placing the ceramic member wrapped in the first and second sheets of preimpregnated carbon fiber into a vacuum bag, sealing the vacuum bag, and applying a vacuum to the vacuum bag. The method can include placing the vacuum bag containing the ceramic member wrapped in the first and second sheets of preimpregnated carbon fiber into a pressure vessel and increasing the pressure in the pressure vessel to about 14.7-145, 25-125, 50-100, or 75-100 psi for a first predetermined duration. The first predetermined duration can be about 1-240, 15-120, 30-90, or 45-60 minutes. The method can include maintaining a temperature in the pressure vessel of about 100-150, 150-200, 200-250, 250-300, or 300-500 degrees Fahrenheit to cure the resin in the first and second sheets of preimpregnated carbon fiber fabric for a second predetermined duration. The second predetermined duration can be about 1-240, 15-120, 30-90, or 45-60 minutes. The pressure vessel can be an autoclave or hydroclave. The method can include inserting a film adhesive layer between the outer surface of the ceramic member and the inner surface of the first sheet of preimpregnated carbon fiber fabric before wrapping the first sheet of preimpregnated carbon fiber fabric around the ceramic member. The film adhesive layer can include polyethylene, polypropylene, ethylene, copolyester, copolyamide, or thermoplastic polyurethane.

In yet another example, a ballistic resistant apparatus for a vehicle, dwelling, or carrier vest can include a ceramic member defined by an outer surface and made of silicon carbide, boron carbide, titanium carbide, tungsten carbide, zirconia toughened alumina, or high-density aluminum oxide. The ballistic resistant apparatus can include a composite layer encasing the ceramic member and providing a compressive force against the outer surface of the ceramic member. The composite layer can include a reinforcing layer impregnated with a matrix material. The matrix material can be a thermoset resin that has been cured at a pressure below 10 atmospheres to harden to form, in combination with the reinforcing layer, the composite layer.

During a manufacturing process, the thermoset resin can be cured at a pressure of about 14.7-145, 25-125, 50-100, or 75-100 psi to harden to form the composite layer. The thermoset resin can be cured while the ballistic resistant apparatus is sealed within an evacuated vacuum bag. The thermoset resin can be cured while the ballistic resistant apparatus was sealed within a vacuum bag and positioned inside an autoclave. The thermoset resin can be cured while the ballistic resistant apparatus is sealed within a vacuum bag, positioned inside an autoclave, and heated to a temperature of about 100-150, 150-200, 200-250, 250-300, or 300-500 degrees Fahrenheit.

Additional objects and features of the invention are introduced below in the Detailed Description and shown in the drawings. While multiple embodiments are disclosed, still other embodiments will become apparent to those skilled in the art from the following Detailed Description, which shows and describes illustrative embodiments. As will be realized, the disclosed embodiments are susceptible to modifications in various aspects, all without departing from the scope of the present disclosure. Accordingly, the drawings and detailed description are to be regarded as illustrative in nature and not restrictive.

This Summary is provided to introduce a selection of concepts in a simplified form that are further described in the Detailed Description below. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTIONS OF DRAWINGS

FIG. 1 shows a carrier vest configured to receive protective inserts in pockets located along front, back, and side surfaces of the carrier vest.

FIG. 2 shows a plurality of ballistic sheets arranged in a stack within a cover to form a soft armor insert for a bullet-proof vest.

FIG. 3 shows a front view of a hard armor insert made of ceramic and configured to fit in a pocket of a carrier vest.

FIGS. 4A, 4B, and 4C shows a series of three images depicting a bullet striking a ceramic insert backed with soft armor. FIG. 4A shows the bullet just prior to impact, FIG. 4B shows the bullet shortly after impact as the ceramic plate begins to break into fragments, and FIG. 4C shows the soft armor catching fragments of the ceramic plate and bullet near the end of the impact event.

FIG. 5 shows a top perspective view of a ballistic resistant apparatus with a hard composite layer encasing a ceramic member where the cured composite layer is made of woven carbon fiber fabric and cured resin.

FIG. 6 shows a side cross-sectional view of the ballistic resistant apparatus shown in FIG. 5 exposing the ceramic member within the hard composite layer and an adhesive layer between the ceramic member and the hard composite layer.

FIG. 7 shows a side cross-sectional view of a ballistic resistant apparatus including a ceramic member and a composite layer containing a first reinforcing material.

FIG. 8 shows a side cross-sectional view of a ballistic resistant apparatus including a ceramic member and a composite layer containing a second reinforcing material.

FIG. 9 shows a side cross-sectional view of a ballistic resistant apparatus including a ceramic member and a composite layer containing a first reinforcing material and a second reinforcing material.

FIG. 10 shows a side cross-sectional view of a ballistic resistant apparatus wrapped in a wear-resistant cover, the ballistic resistant apparatus including a ceramic member encased by a composite layer containing a first reinforcing material and a second reinforcing material.

FIG. 11 shows a side cross-sectional view of a ballistic resistant apparatus having a ceramic member adjacent to a stack of ballistic sheets and encased in a composite layer.

FIG. 12 shows a side cross-sectional view of a ballistic resistant apparatus wrapped in a wear-resistant cover, the ballistic resistant apparatus including a ceramic member adjacent to a stack of ballistic sheets and encased in a composite layer.

FIG. 13 shows a process for wrapping a ceramic member with a first sheet of uncured reinforcing material.

FIG. 14 shows a process for wrapping a ceramic member with a second sheet of uncured reinforcing material after the ceramic member has been wrapped with a first sheet of uncured reinforcing material as shown in FIG. 13.

FIG. 15 shows a ceramic member that has undergone the process steps shown in FIGS. 13 and 14 to produce a ballistic resistant apparatus with a composite layer including a first sheet of reinforcing material and a second sheet of reinforcing material.

FIG. 16 shows a plurality of hexagon-shaped ballistic resistant apparatuses arranged in an array.

FIG. 17 shows a side cross-sectional view of a plurality of ballistic resistant apparatuses arranged in a planar array and encased in a composite layer.

FIG. 18 shows a side cross-sectional view of a plurality of ballistic resistant apparatuses arranged in a contoured array and encased in a composite layer.

FIG. 19 shows a vacuum bagging process for encasing a ceramic member in a composite layer.

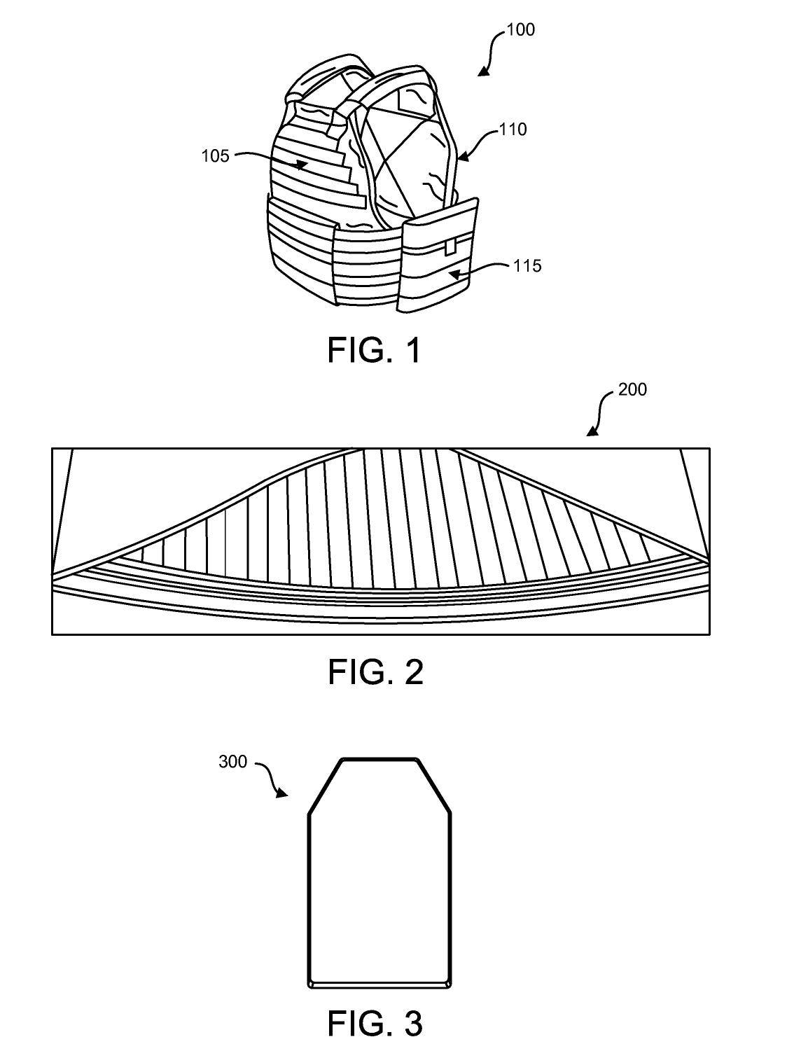

### DETAILED DESCRIPTION

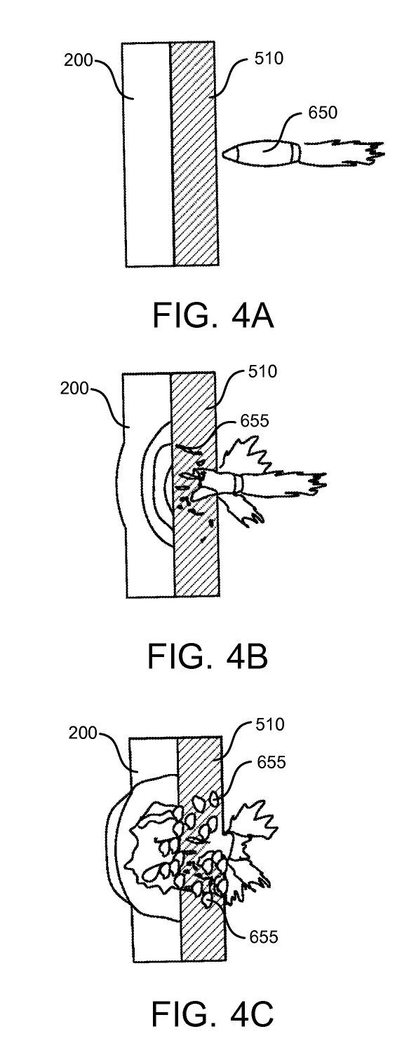

When a ceramic plate 510 is incorporated into hard body armor, it is commonly backed with a soft armor backing 200, as shown in FIG. 4A. When a projectile 650 is fired at the hard body armor, the ceramic plate may stop the projectile, but in doing so, will commonly fracture into many pieces, known as fragments 655, as shown in FIGS. 4B and 4C. The fragments 655, which acquire momentum from the projectile 650, then become projectiles themselves, and must be captured and contained by the soft armor backing 200 so they do not harm the wearer of the body armor. After the ceramic plate 510 has been struck by a single round, it will be heavily damaged and cannot be relied upon to stop additional projectiles. The ceramic plate 510 must then be replaced at a significant cost.

Due to the brittle nature of ceramic plates 510 used in hard body armor (e.g. hard armor inserts), an individual must be extremely careful not to damage the ceramic plate during normal use. For example, when taking off a carrier vest 100 that includes a ceramic plate 510, an individual must be careful not to drop the vest on a hard surface, such as a concrete floor, because the ceramic plate (which is relatively brittle) can crack and must then be replaced. For this reason, and despite their prevalence, existing hard armor inserts containing ceramic plates are not particularly well-suited for combat or training environments where equipment is commonly exposed to rough treatment. In some instances, if a user drops a carrier vest onto a hard surface, the user may be unable to readily assess whether the ceramic plate has sustained any damage, since the hard armor insert may be wrapped in a non-transparent fabric wrapping that prevents the user from observing cracks that may exist in the ceramic plate. In these instances, the user may choose to err on the side of safety and simply discard and replace the hard armor insert rather than risk wearing a damaged insert with a compromised level of ballistic protection. In some instances, after dropping the insert on a hard surface, the ceramic plate may not have actually sustained any appreciable damage. However, without an easy way to confirm this fact, most individuals err on the side of safety, and unnecessarily replace the insert at a considerable cost.

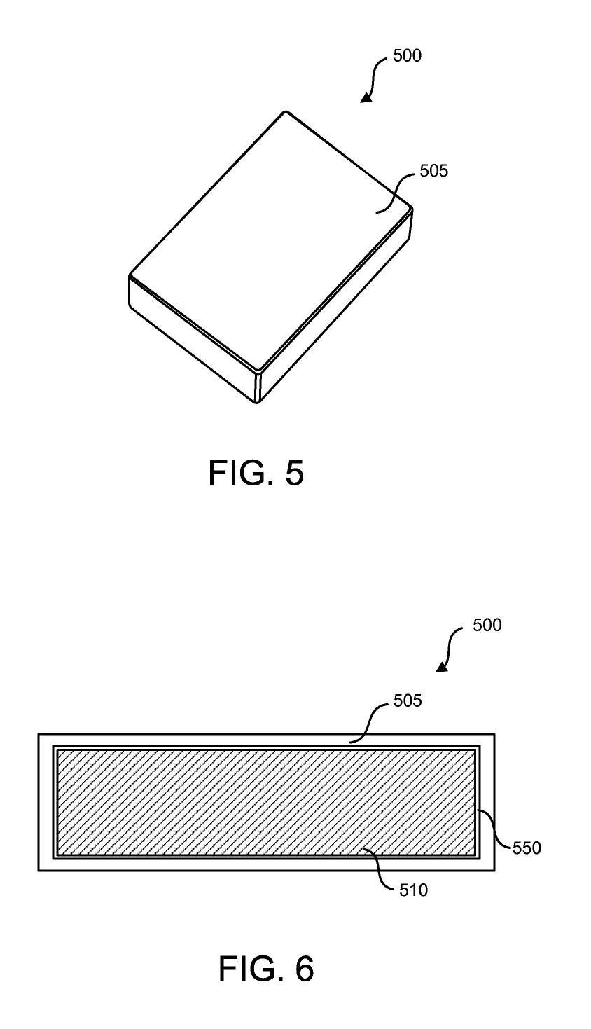

To prevent a ceramic member 510 from fragmenting or cracking during normal use or when struck by a projectile, the ceramic plate can be wrapped with a composite layer 505, as shown in FIG. 5. FIG. 6 shows a side cross-sectional view of the ballistic resistant apparatus 500 shown in FIG. 5, exposing the ceramic member 510 encased within the composite member 505. The addition of the composite layer 505 produces a more durable and better performing ballistic resistant apparatus 500. The composite layer 505 can cover all outer surfaces of the ceramic member 510 to encase the ceramic member with a protective cover that reduces the likelihood of damage resulting to the ceramic member if dropped and provides impressive and unexpectedly higher ballistic performance when struck by a projectile. Experimental testing has revealed that the ballistic resistant apparatus 500, when manufactured according to the processes described herein, exhibits far better ballistic performance than would be expected in view of the sum of the ballistic performance of each of its underlying components.

### Composite Layer

The composite layer 505 of the ballistic resistant apparatus can be made from a reinforcing material combined with a matrix material. In some examples, the reinforcing material can be made from a plurality of fibers arranged into a woven or nonwoven fabric. To produce the fabric, an individual fiber, known as a filament or strand, can be combined with other fibers to form a bundle, known as a tow. A plurality of tows can then be combined to form a woven or nonwoven fabric. The reinforcing material can be a fabric that is constructed from graphite fibers (commonly referred to as “carbon fibers”), glass fibers, KEVLAR fibers, carbon nanotubes, or any other suitable high-performance fibers. In some examples, the fabric can be a hybrid of two or more types of high-performance fibers, such as a hybrid fabric made of carbon fibers and KEVLAR fibers. The fabric can be constructed as a woven, knitted, stitched, or nonwoven (e.g. uni-directional) fabric. Examples of suitable woven fabrics include Style 7725 Bi-directional E-Glass (Item No. 1094), Twill Weave Carbon Fiber Fabric (Item No. 1069), and KEVLAR Plain Weave Fabric (Item No. 2469), all available from Fibre Glast Developments Corporation of Brookville, Ohio.

In some examples, the matrix material can be a thermoset resin, such as polyester, vinyl ester, epoxy, phenolic, polyurethane, silicone, polyamide, or polyamide-imide. Of the thermoset resins listed above, polyester, vinyl ester, and epoxy are the most common thermosetting resins. Thermoset resins offer high thermal stability, high rigidity and hardness, and suitable resistance to creep. Thermosetting resins are relatively easy to work with, because at room temperature (and prior to curing), they remain in a liquid state, which allows them to be distributed over a reinforcing material with relative ease. A thermoset resin in a liquid state can be conveniently applied to a reinforcing fabric made of, for instance, fiberglass, carbon fiber, or KEVLAR fibers. In other examples, the matrix material can be a thermoplastic resin.

The woven or nonwoven fabric can be coated or impregnated with matrix material. In some examples, the woven or nonwoven fabric can be pre-impregnated with matrix material and maintained in cold storage to prevent the matrix material from curing, since the fabric would harden and become unworkable if permitted to cure. The matrix material can be selected based on properties of the reinforcing material and the desired attributes of the ballistic resistant apparatus 500. Once the matrix material has been selected, the parameters of a suitable manufacturing process can be selected to adequately cure the resin. Depending on the characteristics of the selected matrix material and reinforcing material, an oven or autoclave may be employed to speed the process of fully curing (i.e. polymerizing) the matrix material to effectively reduce manufacturing cycle times. A variety of suitable temperatures and durations are described herein for fully curing the matrix material using, for example, an oven or autoclave to produce a finished ballistic resistant apparatus 500 with a high-quality surface finish and exceptional ballistic performance.

In some instances, the matrix material can be applied to the reinforcing material during a lamination process, either by hand or through an infusion process. In other instances, the manufacturer of the reinforcing material may introduce matrix material to the reinforcing material to create a pre-impregnated reinforcing material, which is commonly referred to as a “prepreg” fabric. Prepreg fabrics typically require cold storage to ensure the resin does not cure prematurely. Prepreg fabrics can be more convenient to work with than non-prepreg fabrics, since a relatively messy wet layup process can be avoided, but prepreg fabrics can also be more costly due to the expense associated with impregnating the reinforcing material with matrix material prior to shipping and the need for temperature-controlled storage before, during, and after shipping.

As noted above, the matrix material can be a thermosetting resin, such as an epoxy resin, vinyl-ester resin, or polyester resin. Resin selection can be based, at least in part, on fabric compatibility and the intended application and characteristics of the ballistic resistant apparatus 500. In many instances, epoxy resins are desirable for use in composites, since they create strong, light composite parts that are dimensionally stable. An example of a suitable epoxy resin is System 2000 Epoxy Resin (Item No. 2000-A) available from Fibre Glast Developments Corporation.

The System 2000 Epoxy Resin can be mixed with a suitable epoxy hardener, such as 2020 Epoxy Hardener (Item No. 2020-A), 2060 Epoxy Hardener (Item No. 2060-A), or 2120 Epoxy Hardener (Item No. 2120-A) from Fibre Glast Developments Corporation. Selection of an epoxy hardener can be based, at least in part, on desired pot life and working time, which may be dictated by the size and complexity of the ballistic resistant apparatus 500 being produced. For instance, where the apparatus 500 is larger or more complex, a craftsman may need a longer working time to ensure necessary fabrication steps can be completed before the resin cures. Epoxy hardener selection can also be based on desired cure temperature and cure time. A variety of suitable manufacturing temperatures and times are described herein for manufacturing the ballistic resistant apparatus 500. An epoxy hardener should be selected that is compatible with the chosen manufacturing temperature and time. The post-cured service temperature of the ballistic resistant apparatus 500 should also be considered when selecting an epoxy hardener. Specifically, the craftsman should consider where the apparatus will be used and what temperatures will be encountered in that environment. Certain epoxy hardeners, such as 2120 Epoxy Hardener, have service temperatures of over 200 degrees Fahrenheit, which can be desirable for high temperature applications, such as for ballistic resistant apparatuses that will be incorporated into firewalls or engine shrouds of vehicles.

A composite layer 505 containing a combination of carbon fiber fabric and epoxy is an example of an excellent structural component due to its high tensile strength, high compressive strength, high flexural strength, and excellent heat resistance and machinability. The composite layer 505 can be formed over the ceramic member 510 by any suitable process, such as a wet layup process where liquid resin is distributed over a fabric made of carbon or glass fibers to wet out the fabric. The liquid resin can be distributed by hand, by a resin infusion process, or by any other suitable process. The wet layup process can utilize a peel ply layer or mold release agent to prevent the composite structural layer from adhering to a vacuum bag during a vacuum bagging process. An example of a suitable peel ply layer is Peel Ply Release Fabric (Catalog No. VB-P56150) available from U.S. Composites, Inc. of West Palm Beach, Fla.

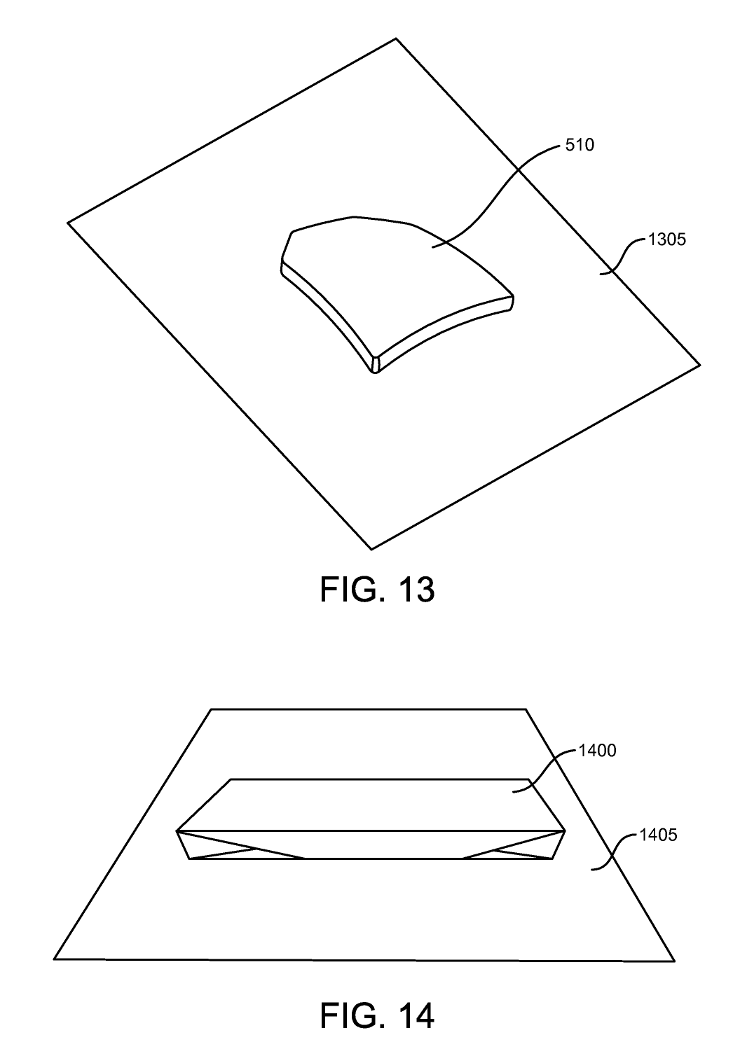

As shown in FIG. 13, during a layup process, the ceramic member 510 can be laid on top of a sheet of reinforcing fabric 1305 that has been trimmed to an appropriate size. The reinforcing fabric 1305 can then be wrapped around the ceramic member 510 to encase the ceramic member. Resin can then be applied to the surface of the reinforcing fabric 1305 using any suitable tool, such as a roller or brush. Through a subsequent vacuum bagging process, the resin will be forced into the fabric to adequately wet out the fabric with resin. When prepreg reinforcing fabric is used to encase the ceramic member, the step of applying resin can be omitted, since the fabric already contains a suitable amount of resin to facilitate the curing process. Regardless of whether prepreg or non-prepreg fabrics are used, it may be necessary to use a peel ply layer between the reinforcing fabric and the vacuum bag to prevent the composite layer 505 formed from the reinforcing fabric 1305 from adhering to the vacuum bag as the resin cures during the vacuum bagging process. Using a peel ply layer can result in a higher quality surface finish on the composite layer 505 and can also protect the vacuum bag from being damaged when removing the finished part from the vacuum bag at the completion of the process, which allows the vacuum bag to be reused. However, where the quality of the composite layer's surface finish is unimportant (e.g. where the composite layer will not be visible in the final product), the peel ply layer can be omitted to reduce process cost and complexity.

To encourage the composite layer 505 to adhere to the ceramic member 510, it may be necessary to insert a layer of resin or film adhesive 550 between the ceramic member 510 and composite layer 505, as shown in FIG. 6. The resin or film adhesive 550 can be an epoxy, epoxy foam, liquid resin, or any other suitable film adhesive. Examples of suitable film adhesives are available from Collano AG, located in Germany. The resin or film adhesive layer 550 may be activated by applying heat and pressure, and upon cooling, will effectively bond the ceramic member 510 to the composite layer 505. The resin or film adhesive layer 550 can be used between any two adjacent surfaces in the ballistic resistant apparatus 500 to improve bonding between the adjacent surfaces.

In some examples, the ceramic member 510 can be wrapped with one or more sheets of reinforcing materials 1305 to form a composite layer 505. The reinforcing materials 1305 can be wrapped around the ceramic member 510 similar to the way a gift box is wrapped with wrapping paper. For instance, a sheet of reinforcing material 1305 can be laid on a flat surface, as shown in FIG. 13. A ceramic member 510 can then be placed on top of the sheet of reinforcing material 1305, and the edges of the sheet of reinforcing material can then be folded up and over the respective edges of the ceramic member (similar to the way a gift is wrapped with wrapping paper) to produce a wrapped ceramic member 1400, as shown in FIG. 14. At this point, if needed, resin can be applied to the exterior of the first sheet of reinforcing material 1305. The wrapped ceramic member 1400 can then be processed according to the process parameters described herein to produce a finished ballistic resistant apparatus 500.

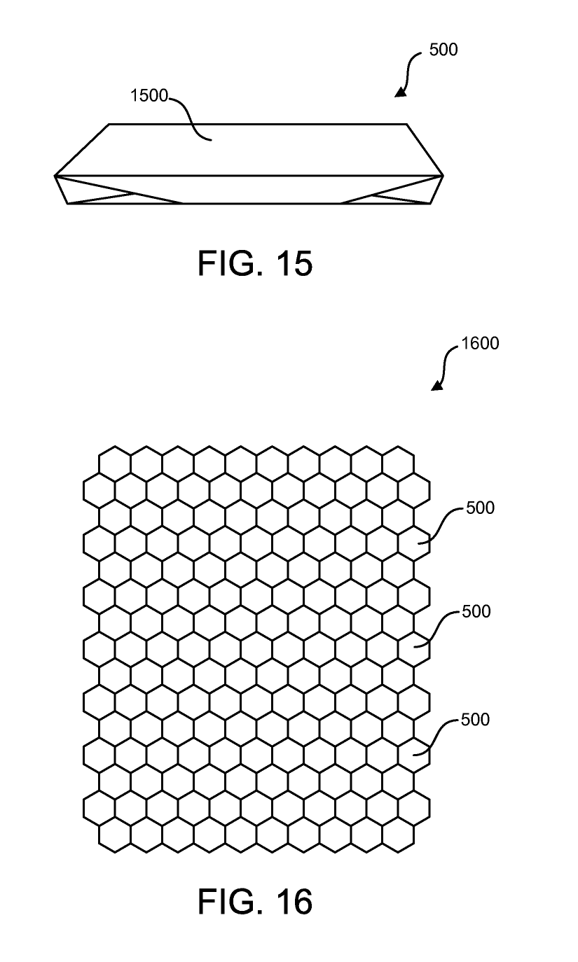

In another example, instead of processing the wrapped ceramic member 1400 after the first sheet of reinforcing material has been applied, a second sheet of reinforcing material 1405 can be applied over the first sheet of reinforcing material 1305 prior to processing. During application of the second sheet of reinforcing material 1405, the wrapped ceramic member 1400 can first be placed on top of the second sheet of reinforcing material 1405, as shown in FIG. 14, and the edges of the second sheet of reinforcing material can then be folded up and over the respective edges of the wrapped ceramic member 1400 (similar to the way a gift is wrapped with wrapping paper) to produce a twice-wrapped ceramic member 1500, as shown in FIG. 15. In some examples, it may be desirable to flip the ceramic member 510 over between application of the first and second sheets of reinforcing material (1305, 1405). For instance, if the front surface of the ceramic member 510 was placed downward against the first sheet of reinforcing material 1305, it may be desirable to flip the ceramic member over so that the rear surface of the ceramic member is facing downward against the second sheet of reinforcing material 1405. At this point, if needed, resin can be applied to the exterior of the second sheet of reinforcing material 1405. The wrapped ceramic member 1500 can then be processed according to the process parameters described herein to produce a finished ballistic resistant apparatus 500, as shown in FIG. 15.

Additional layers of reinforcing material (e.g. three or more layers) can be added to the ceramic member 510 prior to processing to further enhance the structural properties of the ballistic resistant apparatus 500. However, experimental results have shown that just two sheets of reinforcing material provide an excellent improvement in ballistic performance over the underlying ceramic member 510 while only moderately increasing material costs and processing time. Therefore, the twice-wrapped ceramic member 1500 shown in FIG. 15 is particularly well-suited for a wide variety of applications.

### Manufacturing Processes

During processing of the ballistic resistant apparatus 500, the ballistic resistant apparatus can be placed inside a vacuum bag and subjected to a pressure of about 1-10 atmospheres, and preferably a pressure of about 4-6 or 4-7 atmospheres, where one atmosphere is equal to about 14.7 psi. As described herein, processing may also include concurrently heating the ballistic resistant apparatus 500 (e.g. while still sealed within the vacuum bag and while still under pressure) to accomplish prompt and complete curing of the matrix material. As the resin cures during processing, and as a result of pressure applied to the outer surfaces of the composite layer 505 during processing, the composite layer can harden around the ceramic member 510 to tightly encapsulate the ceramic member. Once processing is complete, the resulting hardened composite layer 505 can apply light to moderate compressive forces to the outer surfaces of the ceramic member. Experimental results suggests that compressive forces applied to the exterior surfaces of the ceramic member 510 prevent or limit the ceramic member from fragmenting when struck by a projectile by effectively damping shock waves within the ceramic member. The compressive forces ensure that the composite layer 505 is in close contact with the outer surfaces of the ceramic layer 510, thereby enabling the composite layer to effectively absorb and dissipate shock wave energy from the ceramic member immediately after impact.

The composite layer 505 also serves to bolster the ballistic performance of the apparatus 500 by establishing a sealed volume around the ceramic member 510. When a projectile breaches the composite layer 505 and begins to enter the sealed volume, an equal and opposite force is exerted against the projectile. Because the sealed volume is constructed of a hardened composite layer 505 with high tensile strength, the sealed volume resists any significant expansion in volume at the moment of breach. Therefore, as the projectile breaches the sealed volume and begins to force matter into the sealed volume (e.g. hot gases and the projectile itself), the equal and opposite force serves to resist matter being forced into the sealed volume, since the sealed volume does not simply yield and expand in volume to accommodate the matter attempting to enter the sealed volume. The effects of this equal and opposite force have been observed during experimental testing in the form of projectile fragments and hot gasses being expelled outward from the point of breach in a direction opposite the projectile's original flight path. This equal and opposite force produces mushrooming and fragmentation of the projectile, which are both desirable when attempting to slow and defeat a projectile.

Because the ballistic resistant apparatus 500 prevents or limits fragmenting of the ceramic member 510 when impacted by a projectile, the apparatus is much safer for use in close proximity to a human body than existing hard armor solutions. Moreover, as a result of minimal or no fragmentation of the ceramic member at the impact location, cracks are less likely to propagate from the impact location through the ceramic member and, therefore, the ballistic resistant apparatus 500 can withstand multiple rounds before needing to be replaced, which can be extremely beneficial if the wearer is in the field and does not have access to replacement armor inserts for his/her carrier vest.

### Vacuum Bagging

As noted above, the ballistic resistant apparatus 500 can be manufactured using a vacuum bagging process. A vacuum bagging process can remove air present between the composite layer 505 and the ceramic layer 510 prior to the composite layer curing, thereby reducing the thickness of the ballistic resistant apparatus 500 by reducing the thickness of the composite layer. The vacuum bagging process can also improve the surface finish of the composite layer 505 and improve the overall ballistic performance of the apparatus.

During a manufacturing process, the ceramic member 510 can be wrapped in one or more layers of reinforcing material (e.g. 1305, 1405) and then inserted into a vacuum bag for processing. As noted above, the reinforcing material (e.g. 1305, 1405) of the composite layer can be pre-impregnated with resin or resin can be applied to the reinforcing material through a wet layup process. Alternately, resin can be introduced during the vacuum bagging process through an infusion process. The vacuum bag can be made from any suitable material, such as LEXAN, silicone rubber, TEFLON, fiberglass reinforced polyurethane, fiberglass reinforced polyester, or KEVLAR reinforced rubber. In one example, the vacuum bag can be made from a transparent polymer material, such a Nylon Bagging Film available from U.S. Composites, Inc. of Florida. The vacuum bag can be reusable, which can reduce consumables and decrease labor costs.

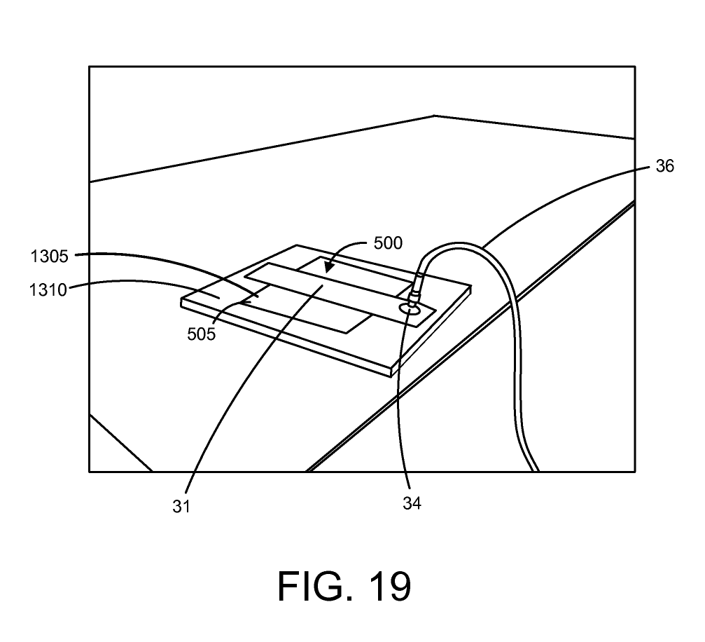

A vacuum hose 36 extending from a vacuum pump can be connected to a vacuum port 34 located in the vacuum bag 1310, as shown in FIG. 19. The vacuum pump can be operated to evacuate air from a sealed volume located between an inner surface of the vacuum bag 1310 and the part (e.g. 500) located within the bag. A breather layer 31 can be positioned between the inner surface of the vacuum bag 1310 and the outer surface of the composite layer 505 to improve evacuation of air from the sealed volume. The breather layer 31 can be made of an air-permeable material that provides an air pathway to encourage evacuation of air from all internal regions of the sealed volume. As air is evacuated from the sealed volume, the air pressure inside the sealed volume decreases. Meanwhile, ambient air pressure acting on the outer surface of the vacuum bag remains at atmospheric pressure (e.g. ˜14.7 psi). The pressure differential between the air pressure inside and outside of the vacuum bag is sufficient to produce a compressive force acting on the apparatus 500. The compressive force is applied uniformly to the apparatus 500, which can produce a ballistic resistant apparatus with uniform or nearly uniform thickness, and can also improve surface finish of the outer surface of the composite layer 505.

The pressure differential established between the ambient air pressure acting on the outer surface of the vacuum bag 1310 and the reduced air pressure acting on the inner surface of the vacuum bag can produce a ballistic resistant apparatus 500 that is thinner than the apparatus was prior to the vacuum bagging process. In many applications, reducing the thickness of the apparatus 500, even if only by a small percentage (e.g. about 1-5 or 5-10%), can be highly desirable. For instance, if implementation dictates that the apparatus 500 is constrained to a certain thickness (e.g. for use in a carrier vest or vehicle door), by vacuum bagging the apparatus, the thickness of the apparatus can be reduced, thereby permitting either a thicker ceramic member or a thicker composite layer to be incorporated into the stack without exceeding design constraints for thickness. By incorporating a thicker ceramic member 510 or thicker composite layer 505, the ballistic performance of the apparatus 500 can be enhanced. In certain applications, such as in body armor or vehicle armor (e.g. ballistic resistant doors or panels for military vehicles, such as tanks, trucks, or mine-resistant ambush protected vehicles), improving the ballistic performance of the armor, even if only incrementally, can be a life-saving improvement.

### Applying Heat

The ballistic resistant apparatus 500 can be manufactured using a heating process. Heating can promote curing and hardening of the matrix material within the composite layer 505. Heating can also promote bonding of the composite layer to the ceramic member 510, especially when a film adhesive layer is present between the ceramic layer and the composite layer as shown in FIG. 6. Heating the ballistic resistant apparatus can effectively reduce manufacturing cycle times, since it can accelerate curing of the matrix material.

Heating the ballistic resistant apparatus can be accomplished by using any suitable heating equipment such as, for example, a conventional oven, infrared oven, hydroclave, or autoclave. To ensure accurate temperature control throughout the heating process, the heating equipment can include a control loop feedback controller, such as a proportional-integral-derivative (PID) controller. To avoid temperature variations throughout a heating chamber of the heating equipment, a fan can be installed and operated within the heating chamber. The fan can circulate air throughout the heating chamber, thereby encouraging mixing of higher and lower temperature regions that may form within the heating chamber (due, for example, to non-uniform placement of heating elements within the heating chamber), and attempting to produce a consistent air temperature adjacent to all outer surfaces of the apparatus to ensure consistent curing of the matrix material. In some examples, the heating chamber can be located within, or can be the same apparatus as, the pressure vessel described herein.

In one example, heating the ballistic resistant apparatus 500 can occur concurrently while the apparatus is sealed within the vacuum bag. In another example, that ballistic resistant apparatus can be heated after a vacuum bagging process is complete and after the apparatus has been removed from the vacuum bag. In yet another example, heating can occur before the ballistic resistant apparatus 500 has been subjected to a vacuum bagging process. In this example, the heating process may include a relatively short heating period (e.g. to avoid curing the matrix material completely. The goal of heating the matrix material prior to vacuum bagging may simple be to initiate (i.e. jump-start) the curing process prior to the vacuum bagging process to reduce the necessary resident time of the apparatus within the vacuum bag. Once pre-heated and inserted and sealed within the vacuum bag, curing can be permitted to proceed to completion. This approach ensures that benefits of the vacuum bagging process (e.g. compression and thinning of the apparatus) will be realized before the matrix material begins to harden and becomes, essentially, uncompressible.

During the heating process, a process temperature can be selected based, at least in part, on properties of the matrix material or properties of the reinforcing layer. For instance, if the manufacturer of the matrix material recommends curing the matrix material at a temperature of at least 70 degrees Fahrenheit, a process temperature of at least 70 degrees Fahrenheit can be selected. By increasing the process temperature above the minimum curing temperature recommended by the manufacturer of the matrix material, curing can be accelerated, thereby reducing manufacturing cycle times, speeding production capacity, and freeing equipment and personnel for other tasks.

To promote accelerated curing of the matrix material to form a hardened composite layer 505, the ballistic resistant apparatus 500 can be heated to a suitable temperature for a suitable duration. Suitable temperatures and durations may depend on the resin type and whether vacuum and/or pressure are applied to the ballistic resistant apparatus during the heating process. An example of a suitable process temperature and suitable process duration for a heating process is about 240-290 degrees Fahrenheit and about 45-90 minutes, respectively. Other examples of suitable process temperatures and durations for a heating process can include: 125-550 degrees F. for at least 1 second; 125-550 degrees F. for at least 5 minutes; 125-550 degrees F. for at least 15 minutes; 125-550 degrees F. for at least 30 minutes; 125-550 degrees F. for at least 60 minutes; 125-550 degrees F. for at least 90 minutes; 125-550 degrees F. for at least 120 minutes; 125-550 degrees F. for at least 180 minutes; 125-550 degrees F. for at least 240 minutes; 125-550 degrees F. for at least 480 minutes; 225-350 degrees F. for at least 1 second; 225-350 degrees F. for at least 5 minutes; 225-350 degrees F. for at least 15 minutes; 225-350 degrees F. for at least 30 minutes; 225-350 degrees F. for at least 60 minutes; 225-350 degrees F. for at least 90 minutes; 225-350 degrees F. for at least 120 minutes; 225-350 degrees F. for at least 180 minutes; 225-350 degrees F. for at least 240 minutes; 250-350 degrees F. for at least 1 second; 250-350 degrees F. for at least 5 minutes; 250-350 degrees F. for at least 15 minutes; 250-350 degrees F. for at least 30 minutes; 250-350 degrees F. for at least 60 minutes; 250-350 degrees F. for at least 90 minutes; 250-350 degrees F. for at least 120 minutes; 250-350 degrees F. for at least 180 minutes; 250-350 degrees F. for at least 240 minutes; 250-300 degrees F. for at least 1 second; 250-300 degrees F. for at least 5 minutes; 250-300 degrees F. for at least 15 minutes; 250-350 degrees F. for at least 30 minutes; 250-300 degrees F. for at least 60 minutes; 250-350 degrees F. for at least 90 minutes; 250-300 degrees F. for at least 120 minutes; 250-300 degrees F. for at least 180 minutes; 250-300 degrees F. for at least 240 minutes; 225-275 degrees F. for at least 1 second; 225-275 degrees F. for at least 5 minutes; 225-275 degrees F. for at least 15 minutes; 225-275 degrees F. for at least 30 minutes; 225-275 degrees F. for at least 60 minutes; 225-275 degrees F. for at least 90 minutes; 225-275 degrees F. for at least 120 minutes; 225-275 degrees F. for at least 180 minutes; 225-275 degrees F. for at least 240 minutes; 225-250 degrees F. for at least 1 second; 225-250 degrees F. for at least 5 minutes; 225-250 degrees F. for at least 15 minutes; 225-250 degrees F. for at least 30 minutes; 225-250 degrees F. for at least 60 minutes; 225-250 degrees F. for at least 90 minutes; 225-250 degrees F. for at least 120 minutes; 225-250 degrees F. for at least 180 minutes; 225-250 degrees F. for at least 240 minutes; 240-260 degrees F. for at least 1 second; 240-260 degrees F. for at least 5 minutes; 240-260 degrees F. for at least 15 minutes; 240-260 degrees F. for at least 30 minutes; 240-260 degrees F. for at least 60 minutes; 240-260 degrees F. for at least 90 minutes; 240-260 degrees F. for at least 120 minutes; 240-260 degrees F. for at least 180 minutes; 240-260 degrees F. for at least 240 minutes; 140-225 degrees F. for at least 1 second; 140-225 degrees F. for at least 5 minutes; 140-225 degrees F. for at least 15 minutes; 140-225 degrees F. for at least 30 minutes; 140-225 degrees F. for at least 60 minutes; 140-225 degrees F. for at least 90 minutes; 140-225 degrees F. for at least 120 minutes; 140-225 degrees F. for at least 180 minutes; or 140-225 degrees F. for at least 240 minutes.

For any of the above-mentioned process temperatures and durations for a heating process, the ballistic resistant apparatus 500 can be sealed within a vacuum bag 1310 during the heating process. In certain examples, a vacuum hose 36 extending from a vacuum pump can remain connected to a vacuum port 34 on the vacuum bag 1310 during the heating process. This configuration can ensure good results even if the vacuum bag is not perfectly sealed, since the application of constant vacuum will evacuate any air that may leak into the bag due to the pressure differential.

### Applying Pressure

During manufacturing of the ballistic resistant apparatus 500, pressure can be applied to the apparatus. Appling pressure to the ballistic resistant apparatus 500 can improve the ballistic performance of the apparatus. Applying pressure to ballistic resistant apparatus 500 can also reduce the thickness of the apparatus (e.g. by about 1-5 or 5-10 percent, depending on the number of sheets of reinforcing material used) by preventing air or gas pockets from forming between the ceramic member 510 and the composite layer 505 as the matrix material off-gases during curing.

Pressure can be applied to the ballistic resistant apparatus 500 using a mechanical press, autoclave, hydroclave, bladder press, or other suitable device. In one example, pressure can be applied to the ballistic resistant apparatus 500 during the heating process. In another example, pressure can be applied to the ballistic resistant apparatus 500 before the heating process. In yet another example, pressure can be applied to the ballistic resistant apparatus 500 after the heating process.

If pressure is applied to the ballistic resistant apparatus 500, it can be applied while the ballistic resistant apparatus is positioned inside the vacuum bag (and while subjected to vacuum) and while the apparatus is maintained at a process temperature above room temperature (e.g. above 70 degrees Fahrenheit) to promote curing of the matrix material. Alternately, pressure can be applied to the apparatus 500 after the apparatus has been removed from the vacuum bag or before the apparatus is inserted into the vacuum bag. In any of these scenarios, pressure should preferably be applied to the ballistic resistant apparatus 500 before curing advances to a point where the matrix material begins to harden and become unworkable.

An example of a suitable process pressure and duration is less than 10 atmospheres (i.e. less than 147 psi) and about 45-90 minutes, respectively. Another suitable process pressure and duration is about 4-7 atmospheres and about 45-90 minutes, respectively. Yet another suitable process pressure and duration is about 4-6 atmospheres and about 45-90 minutes, respectively. Other examples of suitable process pressures and durations can include, for example: 10-100 psi for at least 1 second, 10-100 psi for at least 1 minute; 10-100 psi for at least 5 minutes; 10-100 psi for at least 15 minutes; 10-100 psi for at least 30 minutes; 10-100 psi for at least 60 minutes; 10-100 psi for at least 90 minutes; 10-100 psi for at least 120 minutes; 10-100 psi for at least 180 minutes; 10-100 psi for at least 240 minutes; 50-75 psi for at least 1 second; 50-75 psi for at least 5 minutes; 50-75 psi for at least 15 minutes; 50-75 psi for at least 30 minutes; 50-75 psi for at least 60 minutes; 50-75 psi for at least 90 minutes; 50-75 psi for at least 120 minutes; 50-75 psi for at least 180 minutes; 50-75 psi for at least 240 minutes; 50-100 psi for at least 1 second; 50-100 psi for at least 5 minutes; 50-100 psi for at least 15 minutes; 50-100 psi for at least 30 minutes; 50-100 psi for at least 60 minutes; 50-100 psi for at least 90 minutes; 50-100 psi for at least 120 minutes; 50-100 psi for at least 180 minutes; 50-100 psi for at least 240 minutes; at least 10 psi for at least 1 second; at least 10 psi for at least 5 minutes; at least 10 psi for at least 15 minutes; at least 10 psi for at least 30 minutes; at least 10 psi for at least 60 minutes; at least 10 psi for at least 90 minutes; at least 100 psi for at least 120 minutes; at least 10 psi for at least 180 minutes; at least 10 psi for at least 240 minutes; at least 100 psi for at least 1 second; at least 100 psi for at least 5 minutes; at least 100 psi for at least 15 minutes; at least 100 psi for at least 30 minutes; at least 100 psi for at least 60 minutes; at least 100 psi for at least 90 minutes; at least 100 psi for at least 120 minutes; at least 100 psi for at least 180 minutes; or at least 100 psi for at least 240 minutes.

Lower pressures may be achievable with, for example, a manual press or a relatively small autoclave. In the examples described above, pressures below 10 atmospheres may be used to produce highly-effective ballistic resistant apparatuses 500. Lower process pressures can be desirable over higher process pressures, since lower pressures allow for faster cycle times, since pressurization and depressurization of the pressure vessel can be accomplished more quickly. Also, a less robust pressure vessel can be used, which can dramatically reduce manufacturing capital expenses. For instance, a robust, industrial autoclave that is capable of achieving higher pressures (e.g. greater than 10 atmospheres) can cost half a million dollars or more, whereas an autoclave that is capable of achieving lower pressures (e.g. 1-10 atmospheres) may cost only a small fraction of that amount.

In some examples, higher pressures can be applied to ballistic resistant apparatus 500 by, for example, an industrial autoclave, hydroclave, bladder press (e.g. made of KEVLAR reinforced rubber), a pneumatic press, or a hydraulic press. Examples of suitable process pressures and durations can include, for example: at least 500 psi for at least 1 second; at least 500 psi for at least 5 minutes; at least 500 psi for at least 15 minutes; at least 500 psi for at least 30 minutes; at least 500 psi for at least 60 minutes; at least 500 psi for at least 90 minutes; at least 500 psi for at least 120 minutes; at least 500 psi for at least 180 minutes; at least 500 psi for at least 240 minutes; at least 1,000 psi for at least 1 second; at least 1,000 psi for at least 5 minutes; at least 1,000 psi for at least 15 minutes; at least 1,000 psi for at least 30 minutes; at least 1,000 psi for at least 60 minutes; at least 1,000 psi for at least 90 minutes; at least 1,000 psi for at least 120 minutes; at least 1,000 psi for at least 180 minutes; or at least 1,000 psi for at least 240 minutes; at least 2,500 psi for at least 1 second; at least 2,500 psi for at least 5 minutes; at least 2,500 psi for at least 15 minutes; at least 2,500 psi for at least 30 minutes; at least 2,500 psi for at least 60 minutes; at least 2,500 psi for at least 90 minutes; at least 2,500 psi for at least 120 minutes; at least 2,500 psi for at least 180 minutes; or at least 2,500 psi for at least 240 minutes.

Examples of other suitable process pressures and durations can include, for example: 40-90 psi for at least 1 second; 40-90 psi for at least 1 minute; 40-90 psi for at least 5 minutes; 40-90 psi for at least 15 minutes; 40-90 psi for at least 30 minutes; 40-90 psi for at least 60 minutes; 40-90 psi for at least 90 minutes; 40-90 psi for at least 120 minutes; 40-90 psi for at least 180 minutes; 40-90 psi for at least 240 minutes; 60-90 psi for at least 1 second; 60-90 psi for at least 1 minute; 60-90 psi for at least 5 minutes; 60-90 psi for at least 15 minutes; 60-90 psi for at least 30 minutes; 60-90 psi for at least 60 minutes; 60-90 psi for at least 90 minutes; 60-90 psi for at least 120 minutes; 60-90 psi for at least 180 minutes; 60-90 psi for at least 240 minutes; 90-150 psi for at least 1 second; 90-150 psi for at least 1 minute; 90-150 psi for at least 5 minutes; 90-150 psi for at least 15 minutes; 90-150 psi for at least 30 minutes; 90-150 psi for at least 60 minutes; 90-150 psi for at least 90 minutes; 90-150 psi for at least 120 minutes; 90-150 psi for at least 180 minutes; 90-150 psi for at least 240 minutes; 500-700 psi for at least 1 second; 500-700 psi for at least 1 minute; 500-700 psi for at least 5 minutes; 500-700 psi for at least 15 minutes; 500-700 psi for at least 30 minutes; 500-700 psi for at least 60 minutes; 500-700 psi for at least 90 minutes; 500-700 psi for at least 120 minutes; 500-700 psi for at least 180 minutes; 500-700 psi for at least 240 minutes; 1,100-1,300 psi for at least 1 second; 1,100-1,300 psi for at least 1 minute; 1,100-1,300 psi for at least 5 minutes; 1,100-1,300 psi for at least 15 minutes; 1,100-1,300 psi for at least 30 minutes; 1,100-1,300 psi for at least 60 minutes; 1,100-1,300 psi for at least 90 minutes; 1,100-1,300 psi for at least 120 minutes; 1,100-1,300 psi for at least 180 minutes; 1,100-1,300 psi for at least 240 minutes; 150-2,500 psi for at least 1 second; 150-2,500 psi for at least 1 minute; 150-2,500 psi for at least 5 minutes; 150-2,500 psi for at least 15 minutes; 150-2,500 psi for at least 30 minutes; 150-2,500 psi for at least 60 minutes; 150-2,500 psi for at least 90 minutes; 150-2,500 psi for at least 120 minutes; 150-2,500 psi for at least 180 minutes; or 150-2,500 psi for at least 240 minutes; 2,500-15,000 psi for at least 15 minutes; 2,500-15,000 psi for at least 30 minutes; 2,500-15,000 psi for at least 60 minutes; 2,500-15,000 psi for at least 90 minutes; 2,500-15,000 psi for at least 120 minutes; 2,500-15,000 psi for at least 180 minutes; 2,500-15,000 psi for at least 240 minutes; 15,000-30,000 psi for at least 15 minutes; 15,000-30,000 psi for at least 30 minutes; 15,000-30,000 psi for at least 60 minutes; 15,000-30,000 psi for at least 90 minutes; 15,000-30,000 psi for at least 120 minutes; 15,000-30,000 psi for at least 180 minutes; or 15,000-30,000 psi for at least 240 minutes.

### Examples of Ballistic Resistant Apparatuses

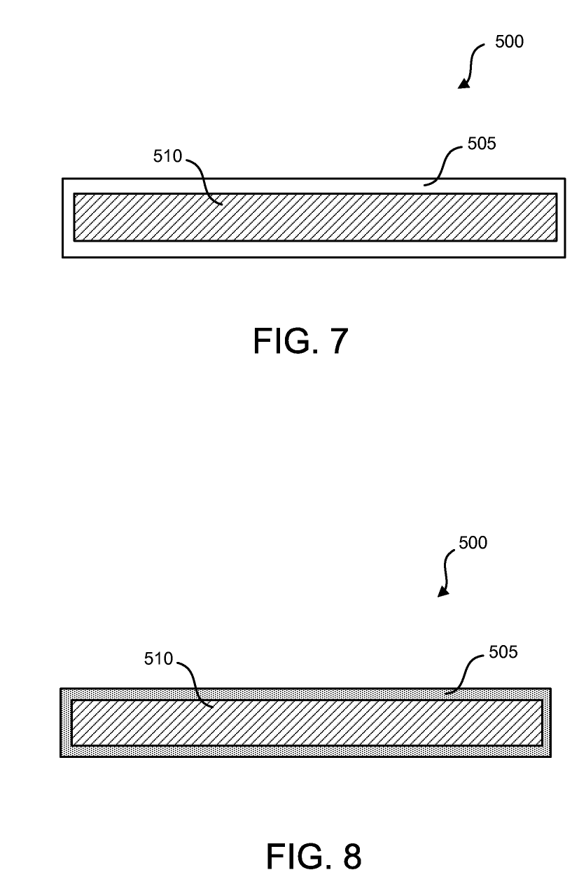

FIG. 7 shows a side cross-sectional view of a ballistic resistant apparatus 500 including a ceramic member 510 and a composite layer 505. The composite layer 505 can encase the ballistic resistant apparatus 500 and can include a reinforcing material combined with a matrix material. In this example, the reinforcing material can be carbon fiber fabric, and the matrix material can be a thermosetting resin. The ballistic resistant apparatus 500 can be processed according to the methods described herein to produce a composite layer 505 that serves as a hard, durable shell that protects the ceramic member from cracking when the apparatus is dropped onto a hard surface. The composite layer 505 can also prevent the ceramic member from fragmenting when the apparatus is struck by a projectile. The apparatus 500 can exhibit significantly improved ballistic performance compared to the ceramic member 510 alone.

FIG. 8 shows a side cross-sectional view of a ballistic resistant apparatus 500 including a ceramic member 510 and a composite layer 505. The composite layer 505 can encase the ballistic resistant apparatus 500 and can include a reinforcing material combined with a matrix material. In this example, the reinforcing material can be a fabric made of aramid fibers (e.g. KEVLAR fibers), and the matrix material can be a thermosetting resin. The ballistic resistant apparatus 500 can be processed according to the methods described herein to produce a composite layer 505 that serves as a hard shell that protects the ceramic member from cracking when the apparatus is dropped onto a hard surface. The composite layer 505 can also prevent the ceramic member 510 from fragmenting when the apparatus is struck by a projectile. The apparatus 500 exhibits significantly improved ballistic performance over the ceramic member 510 alone.

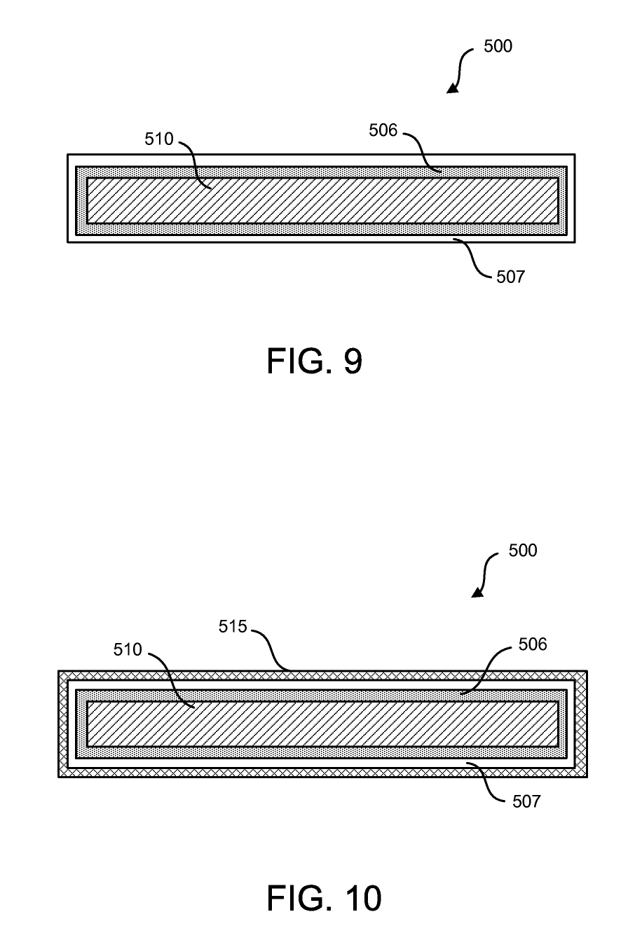

FIG. 9 shows a side cross-sectional view of a ballistic resistant apparatus 500 including a ceramic member 510 and a composite layer. The composite layer can encase the ballistic resistant apparatus 500 and can include a matrix material combined with a first reinforcing material 506 and a second reinforcing material 507. In this example, the first reinforcing material 506 can be a fabric made of aramid fibers (e.g. KEVLAR fibers) or ultra-high molecular weight polyethylene fibers (e.g. DYNEEMA or SPECTA fibers), the second reinforcing material 507 can be a carbon fiber fabric, and the matrix material can be a thermosetting resin. The ballistic resistant apparatus 500 can be processed according to the methods described herein to produce a composite layer that serves as a hard shell that protects the ceramic member from cracking when the apparatus is dropped onto a hard surface. The composite layer can also prevent the ceramic member 510 from fragmenting when the apparatus is struck by a projectile. The apparatus 500 exhibits significantly improved ballistic performance over the ceramic member 510 alone.

### Cover or Coating

In some instances, it may be desirable to encase the ballistic resistant apparatus 500 in a cover or coating. The cover or coating may be wear-resistant, water-resistant, or a combination thereof. In one example, the cover or coating can be a waterproof cover, thereby producing a waterproof ballistic resistant apparatus 500. The cover or coating can be adapted to prevent the ingress of liquid through the cover or coating toward an interior volume of the ballistic resistant apparatus 500. Preventing water ingress can be desirable, since water can lubricate adjacent fibers in a reinforcing fabric, and this lubrication can enable fibers to slip relative to each other, which can thereby decrease ballistic performance of the fabric, such as a ballistic fabric made of aramid fibers. Moisture may also negatively affect tensile strength of certain fibers (e.g. aramid fibers) within a ballistic sheet, thereby resulting in the ballistic sheets being less effective at dissipating impact energy from a projectile.

The cover can be made from any suitable material such as, for example, rubber, NYLON, RAYON, ripstop NYLON, carbon fiber, fiberglass, CORDURA, polyvinyl chloride (PVC), polyurethane, silicone elastomer, fluoropolymer, or any combination thereof. The coating can include polyurethane or epoxy, such as a coating sold by Rhino Linings Corporation, located in San Diego, Calif. In another example, the cover and coating can include any suitable material and coated with a waterproof material such as, for example, rubber, PVC, polyurethane, polytetrafluoroethylene, silicone elastomer, fluoropolymer, wax, or any combination thereof. In one example, the cover and coating can be made from NYLON coated with PVC. In another example, the cover and coating can be made from NYLON coated with thermoplastic polyurethane. The cover and coating can be made of any suitable material, such as about 50, 70, 200, 400, 600, 840, 1050, or 1680-denier NYLON coated with thermoplastic polyurethane. In yet another example, the cover and coating can be made from 1000-denier CORDURA coated with thermoplastic polyurethane.

In addition to protecting the internal components of the apparatus 500 from water ingress, the cover or coating can be made of a chemically-resistant material designed to protect internal components of the apparatus from exposure to certain acids or bases (e.g. battery acid) that may come in contact with external surfaces of the apparatus. Certain acids and bases can cause the tenacity of certain fibers, such as aramid fibers, to degrade over time, where “tenacity” is a measure of strength of a fiber or yarn. It is therefore desirable, in certain applications, for the cover or coating to be resistant to acids or bases to prevent the cover or coating from deteriorating when exposed to acids or bases. Deterioration of the cover or coating would be undesirable, since it could permit acids or bases to breach the cover or coating and reach the internal components inside the cover or coating. To this end, the cover can be made of a chemically resistant material or can include a chemically resistant coating on an outer or inner surface of the cover. For instance, the cover can include a thermoplastic polymer coating on an outer surface of the cover. Examples of chemically-resistant thermoplastic polymers that can be used as a coating on the cover include polypropylene, low-density polyethylene, medium-density polyethylene, high-density polyethylene, ultra-high-molecular-weight polyethylene, and polytetrafluoroethylene (e.g. TEFLON).

The cover or coating can be made of a flame-resistant or flame-retardant material. In one example, the cover can include a base material with a flame-resistant or flame-retardant coating impregnated in the base material. In another example, the cover can include a base material coated with a flame-resistant or flame-retardant material. The flame-resistant or flame-retardant coating can include a phenolic resin, a phenolic/epoxy composite, NOMEX, an organohalogen compound (e.g. chlorendic acid derivative, chlorinated paraffin, decabromodiphenyl ether, decabromodiphenyl ethane, brominated polystyrene, brominated carbonate oligomer, brominated epoxy oligomer, tetrabromophthalic anyhydride, tetrabromobisphenol A, or hexabromocyclododecane), an organophosphorus compound (e.g. triphenyl phosphate, resorcinol bis(diphenylphosphate), bisphenol A diphenyl phosphate, tricresyl phosphate, dimethyl methylphosphonate, aluminum diethyl phosphinate, brominated tris, chlorinated tris, or tetrekis(2-chlorethyl)dichloroisopentyldiphosphate, antimony trioxide, or sodium antimonite), or a mineral (e.g. aluminium hydroxide, magnesium hydroxide, huntite, hydromagnesite, red phosphorus, or zinc borate).

The cover, along with the remainder of the ballistic resistant apparatus 500, can be heated and subjected to a vacuum bagging process as described herein. The heating and vacuum bagging process, can result in partial or full bonding of an inner surface of the cover to the remainder of the ballistic resistant apparatus 500. The cover can include a temperature sensitive adhesive or a layer of resin on an inner surface. The cover can be heated to promote full or partial bonding of the inner surface of the cover to the outer surfaces of the ballistic resistant vehicle door 500 as the layer of adhesive or resin disposed on the inner surface of the cover softens in response to heating and then hardens in response to cooling. In one example, the cover can be made of a material that is coated with polyurethane, polypropylene, vinyl, polyethylene, or any combination thereof, on the inner surface the cover. Heating the cover to a temperature above the melting or softening point of the adhesive or resin and then cooling the cover below the melting or softening point of the adhesive or resin can result in bonding of the inner surface of the cover to outer surfaces of the ballistic resistant vehicle apparatus 500.

In some examples, the cover can be made of ripstop NYLON coated with polyurethane. The cover can be made of ripstop NYLON with a polyurethane coating that is about 0.1-1.5, 0.1-0.75, 0.1-0.5, or 0.25 mil thick. In some examples, the cover can be made of about 70-denier ripstop NYLON with a polyurethane coating that is about 0.1-1.5, 0.1-0.75, 0.1-0.5, or 0.25 mil thick. The polyurethane coating can be provided on an inner surface of the cover as noted above. A durable water repellant finish can be provided on an outer surface of the cover to further enhance performance. Suitable polyurethane-coated ripstop NYLON materials are commercially available under the trademark X-PAC from Rockywoods Fabrics, LLC of Loveland, Colo.

FIG. 10 shows a side cross-sectional view of a ballistic resistant apparatus 500 wrapped or encased in a cover or coating 515 that can be water-resistant, wear-resistant, chemically-resistant, or a combination thereof. The ballistic resistant apparatus 500 can include a ceramic member 510 and a composite layer containing a first reinforcing material 506 and a second reinforcing material 507 that together form the composite layer 505.

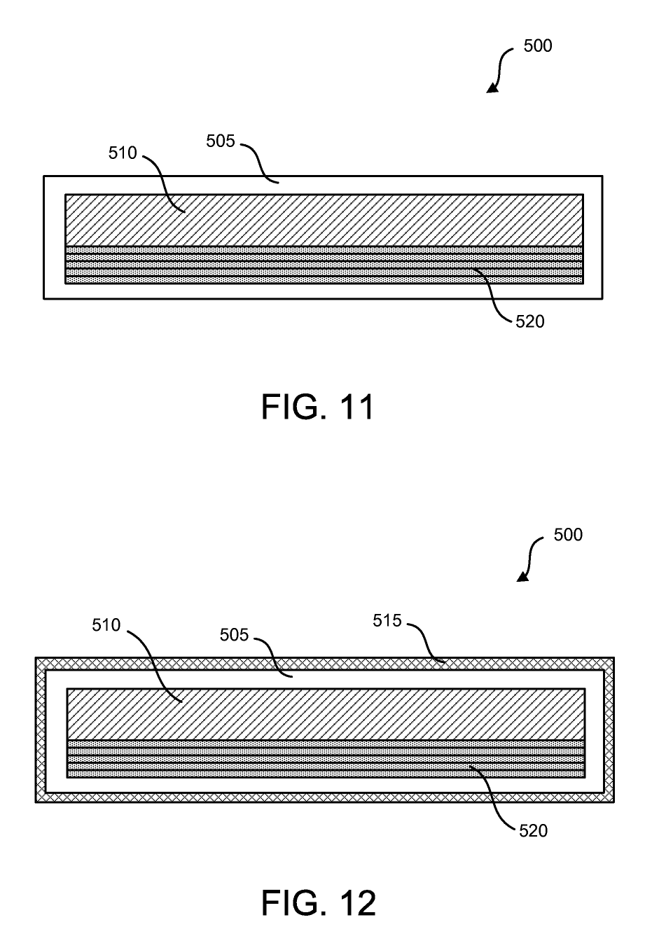

FIG. 11 shows a side cross-sectional view of a ballistic resistant apparatus 500 including a ceramic member 510 adjacent to a stack of ballistic sheets 520. A composite layer 505 encases the ceramic member 510 and the stack of ballistic sheets 520. The stack of ballistic sheets 520 can include one or more of any of the various types of ballistic sheets described below. FIG. 12 shows a side cross-sectional view of a ballistic resistant apparatus 500 similar to the apparatus shown in FIG. 11 but also wrapped or encased in a cover or coating 515 that can be water-resistant, wear-resistant, chemically-resistant, or a combination thereof.

### Ballistic Sheet Construction

The ballistic resistant apparatus 500 described herein can include one or more ballistic sheets 520 as shown, for example, in FIGS. 11 and 12. The term “sheet,” as used herein, can describe one or more layers containing any suitable material, such as a polymer, metal, fiberglass, ceramic, composite, or combination thereof. Examples of polymers include aramids, para-aramids, meta-aramids, polyolefins, and thermoplastic polyethylenes. Commercially-available examples of aramids, para-aramids, and meta-aramids are sold under the trademarks NOMEX, KERMEL, KEVLAR, TWARON, NEW STAR, TECHNORA, HERACRON, and TEIJINCONEX. An example of a polyolefin is sold under the trademark INNEGRA. Examples of thermoplastic polyethylenes include TENSYLON from E. I. du Pont de Nemours and Company, DYNEEMA from Dutch-based DSM, and SPECTRA from Honeywell International, Inc., which are all examples of ultra-high-molecular-weight polyethylenes (UHMWPE). Examples of glass fibers used in ballistic sheets made of fiberglass include A-glass (soda lime silicate glass), C-glass (e.g. calcium borosilicate glass), D-glass (e.g. borosilicate glass), E-glass (e.g. alumina-calcium-borosilicate glass), E-CR-glass (calcium aluminosilicate glass), R-glass (e.g. calcium aluminosilicate glass), S-glass, S-2 glass (e.g. magnesium aluminosilicate glass fibers having diameters ranging from about 5 to 24 μm), and T-glass. Other suitable fibers that can be used in ballistic sheets include M5 (polyhydroquinone-diimidazopyridine), which has high strength and is also fire-resistant.

The ballistic sheets 520 can be constructed using any suitable manufacturing process, such as extruding, die cutting, forming, pressing, weaving, rolling, etc. In certain instances, the ballistic sheet can be manufactured accordingly to a proprietary or trade secreted method. The ballistic sheet can include a woven or nonwoven construction of a plurality of fibers bonded by a resin, such as a thermoplastic polymer, thermoset polymer, elastic resin, or other suitable resin.

In some examples, the ballistic sheets (e.g. 520) can be pre-impregnated with a resin, such as thermoplastic or thermoset polymer including epoxy, phenolic, polyester, urethane, vinyl ester, polyethylene, and bismaleimide (BMI). The resin can be partially cured to allow for easy handling and storage of the ballistic sheet (e.g. 520) prior to formation of the ballistic resistant apparatus 500. To prevent complete curing (e.g. polymerization) of the resin before the sheet is incorporated into the apparatus 500, the ballistic sheet may require cold storage. In other examples, the ballistic sheet may or may not be pre-impregnated, and a sheet of film adhesive may be inserted between two adjacent ballistic sheets to promote bonding of the adjacent ballistic sheets by melting the film adhesive via a heating process. Suitable film adhesives are available from Collano AG.

In another example, the ballistic sheet can be made of ultra-high-molecular-weight polyethylene and can be formed by any suitable process, such as one of the processes described in U.S. Pat. No. 7,923,094 to Harding et al.; U.S. Pat. No. 7,470,459 to Weedon et al.; or U.S. Pat. No. 7,348,053 to Weedon et al., each of which is hereby incorporated by reference in its entirety. The resulting ballistic sheet can have ballistic properties that distinguish it from sheets made of aramid fibers.

### Commercially Available Ballistic Sheets Made of UHWMPE

E. I. du Pont de Nemours and Company (DuPont), located in Delaware, manufactures a ballistic sheet material made of ultra-high-molecular-weight polyethylene that is sold under the trademark TENSYLON. In some examples, the UHMWPE ballistic sheets can be bidirectional pre-impregnated composite sheets. A Material Data Safety Sheet was prepared on Feb. 2, 2010 for a material sold under the tradename TENSYLON HTBD-09-A (Gen 2) by BAE Systems TENSYLON High Performance Materials. The Material Safety Data Sheet is identified as TENSYLON MSDS Number 1005 and is hereby incorporated by reference in its entirety. Ballistic sheets (e.g. 520) made of TENSYLON are lightweight and cost-effective and boast low back face deformation, excellent flexural modulus, and superior multi-threat capability over other commercially available ballistic sheets. The ballistic material can be purchased on a roll and can be cut into ballistic sheets having a size and shape dictated by an intended application.

### Commercially Available Ballistic Sheets Made of Aramid Fibers

Ballistic sheets constructed from high performance fibers, such as aramid, para-aramids, or meta-aramids fibers, are commercially available from several manufacturers. Ballistic sheets are commercially available in various configurations, including uni-ply, 0/90 x-ply, and 0/90/0/90 double x-ply configurations. Ballistic sheeting material can be ordered in a wide variety of forms, including tapes, laminates, rolls, sheets, structural sandwich panels, and preformed inserts, which can all be cut to size during one or more manufacturing processes and incorporated into a ballistic resistant apparatus 500, as shown in FIGS. 11 and 12.

TechFiber, LLC, located in Arizona, manufactures a variety of ballistic sheets made of aramid fibers that are sold under the trademark K-FLEX. One version of K-FLEX is made with KEVLAR fibers with a denier of about 1000 and can have a pick count of about 18 picks/inch. K-FLEX can have a resin content of about 15-20%. Different versions of K-FLEX ballistic sheets may contain different resins. For instance, a first version of K-FLEX may contain a resin with a melting temperature of about 325 degrees F., a second version of K-FLEX may contain a resin with a melting temperature of about 266 degrees F., and a third version of K-FLEX may contain a resin with a melting temperature of about 250 degrees F. K-FLEX is available in uni-ply, 0/90 x-ply, and 0/90/0/90 double x-ply configurations.

TechFiber, LLC also manufactures a variety of ballistic sheets made of aramid fibers that are sold under the trademark T-FLEX. Different versions of T-FLEX ballistic sheets can contain different resins. A first version of T-FLEX can include a resin with a melting temperature of about 325 degrees F., a second version of T-FLEX can include a resin with a melting temperature of about 266 degrees F., and a third version of T-FLEX can include a resin with a melting temperature of about 250 degrees F. Certain versions of T-FLEX have a resin content of about 15-20% and include aramid fibers such as TWARON fibers (e.g. model number T765). T-FLEX is available in uni-ply, 0/90 x-ply, and 0/90/0/90 double x-ply configurations.

Polystrand, Inc., located in Colorado, manufactures a variety of ballistic sheets made of aramid fibers that are sold under the trademark THERMOBALLISTIC. One version of THERMOBALLISTIC ballistic sheets are sold as product number TBA-8510 and include KEVLAR fibers with a pick count of about 12.5 picks per inch. Different versions of THERMOBALLISTIC ballistic sheets can contain different resins. One version of THERMOBALLISTIC ballistic sheets can include a resin with a melting temperature of about 355 degrees F. One version of THERMOBALLISTIC ballistic sheets can include a polypropylene resin. The resin content of the THERMOBALLISTIC ballistic sheets can be about 15-20%. THERMOBALLISTIC ballistic sheets are available in uni-ply, 0/90 x-ply, and 0/90/0/90 double x-ply configurations.

Honeywell International, Inc., headquartered in New Jersey, manufactures a variety of ballistic sheets made of aramid fibers that are sold under the trademark GOLD SHIELD. One version of GOLD SHIELD ballistic sheets is sold as product number GN-2117 and is available in 0/90 x-ply configurations and have an areal density of about 3.24 ounces per square yard.

Barrday, Inc., headquartered in Cambridge, Ontario, manufactures a variety of ballistic sheets made of para-aramid fibers that are sold under the trademark BARRFLEX. One version of BARRFLEX ballistic sheets is sold as product number U480 and is available in 0/90 x-ply configurations. Each layer of the ballistic sheet is individually constructed with a thermoplastic film laminated to a top and bottom surface.

### Arrays of Ballistic Resistant Apparatuses

In many cases, it can be desirable to protect large surfaces using the ballistic resistant technology described herein. For example, it may be desirable to use the ballistic resistant technology described herein to protect governmental, commercial, or residential buildings (e.g. banks, homes, schools, office buildings, prisons, restaurants, laboratories, churches, and convenience stores) or to protect vehicles (military, commercial, or civilian) from ballistic threats. However, in many cases, covering large surfaces would require large or contoured ceramic plates. Large ceramic plates typically need to be special ordered from ceramic manufacturers and can be extremely costly to manufacture. Large ceramic plates also tend to be more fragile than small ceramic plates. For these reasons, large ceramic plates are not well-suited for use in large ballistic resistant products. As an alternative to using large ceramic plates to form large ballistic resistant apparatuses, a large ballistic resistant apparatus can instead be formed from a plurality of smaller, more affordable ceramic plates arranged to form a large array of ballistic resistant apparatuses 1600. The ballistic resistant apparatuses 500 can be arranged in a tessellated array 1600 of polygonal shapes (e.g. triangles, squares, or rectangles) or non-polygonal shapes. In one example shown in FIG. 16, the ballistic resistant apparatuses 500 can be arranged into a tessellated array 1600 of hexagon-shaped ballistic resistant apparatuses 500 where no gaps exist between adjacent apparatuses.

In some examples, the ballistic resistant apparatuses 500 can be arranged into an array 1600 and affixed to a flexible or rigid backing plate, such as a fabric, metal, polymer, or composite backing plate. The backing plate can be flat or formed into a contoured or complexly contoured shape, such as a contoured vehicle door skin. The ballistic resistant apparatuses 500 can be attached to the backing plate by any suitable attachment feature or features including, mechanical fasteners, hook and loop fasteners, interlocking features, or adhesives. In the event that one of the ballistic resistant apparatuses 500 is struck by a projectile and requires replacement, the damaged apparatus can simply be detached from the backing plate and replaced with an undamaged ballistic resistant apparatus. In this way, the array of ballistic resistant apparatuses 1600 can undergo routine maintenance and continue to offer exceptional and undiminished ballistic protection for an extended period of time. Due to the interchangeability of the apparatuses 500 in the array 1600, the ballistic performance of certain areas of the array can easily be upgraded by installing apparatuses with greater ballistic protection. This can allow users to easily upgrade an area of the array 1600 that will be protecting a sensitive or valuable component such as, for example, a computer control system or communication system.

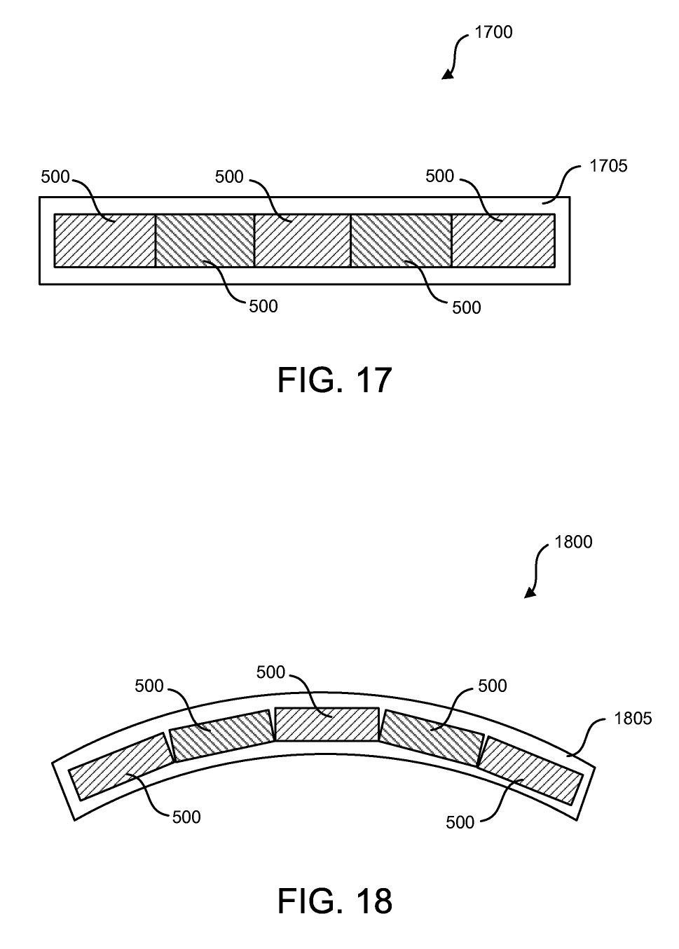

As an alternative to using a backing plate in the array 1600, in some cases a composite layer 705 can be used to encapsulate the array of ballistic resistant apparatuses (e.g. 1700, 1800), as shown in FIGS. 17 and 18. FIG. 17 shows a side cross-sectional view of a plurality of ballistic resistant apparatuses 500 arranged in a planar array 1700 and encased in a composite layer 1705. FIG. 18 shows a side cross-sectional view of a plurality of ballistic resistant apparatuses 500 arranged in a contoured array 1800 and encased in a composite layer 1805. The composite layers (1705, 1805) can be formed by any of the processes described herein, including vacuum bagging, heating, and applying pressure to the array for a predetermined duration. Once processed and hardened, the composite layer (1705, 1805) of the apparatus (1700, 1800) can serve as a structural member, which can provide load-bearing capabilities. Consequently, the apparatus (1700, 1800) can serve as a structural member of, for example, a vehicle, building, or any other object requiring a member that has both structural and ballistic capabilities.

### Ballistic Performance Standards

The ballistic resistant apparatuses 500 described herein can be configured to comply with certain performance standards, such as those set forth in NIJ Standard-0101.06, Ballistic Resistance of Body Armor (July 2008), which is hereby incorporated by reference in its entirety. The National Institute of Justice (NIJ), which is part of the U.S. Department of Justice (DOJ), is responsible for setting minimum performance standards for law enforcement equipment, including minimum performance standards for police body armor. Under NIJ Standard-0101.06, personal body armor is classified into five categories (IIA, II, IIIA, III, IV) based on ballistic performance of the armor. Type HA armor that is new and unworn is tested with 9 mm Full Metal Jacketed Round Nose (FMJ RN) bullets with a specified mass of 8.0 g (124 gr) and a velocity of 373 m/s±9.1 m/s (1225 ft/s±30 ft/s) and with .40 S&W Full Metal Jacketed (FMJ) bullets with a specified mass of 11.7 g (180 gr) and a velocity of 352 m/s±9.1 m/s (1155 ft/s±30 ft/s). Type II armor that is new and unworn is tested with 9 mm FMJ RN bullets with a specified mass of 8.0 g (124 gr) and a velocity of 398 m/s±9.1 m/s (1305 ft/s±30 ft/s) and with .357 Magnum Jacketed Soft Point (JSP) bullets with a specified mass of 10.2 g (158 gr) and a velocity of 436 m/s±9.1 m/s (1430 ft/s±30 ft/s). Type IIIA armor that is new and unworn is tested with .357 SIG FMJ Flat Nose (FN) bullets with a specified mass of 8.1 g (125 gr) and a velocity of 448 m/s±9.1 m/s (1470 ft/s±30 ft/s) and with .44 Magnum Semi Jacketed Hollow Point (SJHP) bullets with a specified mass of 15.6 g (240 gr) and a velocity of 436 m/s±9.1 m/s (1430 ft/s±30 ft/s).

Under the NIJ standard, Type III hard armor or plate inserts are tested in a conditioned state with 7.62 mm FMJ, steel jacketed bullets (U.S. Military designation M80) with a specified mass of 9.6 g (147 gr) and a velocity of 847 m/s±9.1 m/s (2780 ft/s±30 ft/s). Type III flexible armor is tested in both “as new” and “conditioned” states with 7.62 mm FMJ, steel jacketed bullets (U.S. Military designation M80) with a specified mass of 9.6 g (147 gr) and a velocity of 847 m/s±9.1 m/s (2780 ft/s±30 ft/s). Type IV flexible armor is tested in both “as new” state and “conditioned” states with .30 caliber AP bullets (U.S. Military designation M2 AP) with a specified mass of 10.8 g (166 gr) and a velocity of 878 m/s±9.1 m/s (2880 ft/s±30 ft/s). For a Type III hard armor or plate insert that is tested as an “in conjunction” design with flexible armor, the flexible armor is tested in accordance with the NIJ standard as a stand-alone armor at a specified threat level. The combination of the flexible armor and hard armor/plate is then tested as a system and is found to provide protection at the system's specified threat level.

Under the NIJ standard, Type IV hard armor or plate inserts are tested in a conditioned state with .30 caliber armor piercing (AP) bullets (U.S. Military designation M2 AP) with a specified mass of 10.8 g (166 gr) and a velocity of 878 m/s±9.1 m/s (2880 ft/s±30 ft/s). Type IV flexible armor is tested in both “as new” and “conditioned” states with .30 caliber AP bullets (U.S. Military designation M2 AP) with a specified mass of 10.8 g (166 gr) and a velocity of 878 m/s±9.1 m/s (2880 ft/s±30 ft/s). For a Type IV hard armor or plate insert that is tested as an “in conjunction” design with flexible armor, the flexible armor is tested in accordance with the NIJ standard and is found compliant as a stand-alone armor at its specified threat level. The combination of flexible armor and hard armor/plate is then tested as a system and is found to provide protection at the system's specified threat level.

The ballistic resistant vehicle doors 500 described herein can be configured to comply with other performance standards, such as those set forth in the U.S. Department of Defense's Test Method Standard for Test Methods for Ballistic Defeat Materials (MIL-STD-3038, May 2011), which is hereby incorporated by reference in its entirety. The military standard covers test methods for ballistic defeat materials and solutions intended to provide protection against projectiles. The military standard provides types, classifications, and grades based on ballistic protection limit (i.e. ballistic resistance). The classifications of ballistic resistant materials are based on the lethality of the projectile and cartridge used for testing.

The term “ballistic limit” describes the impact velocity required to perforate a target with a certain type of projectile. To determine the ballistic limit of a target, a series of experimental tests must be conducted. During the tests, the velocity of the certain type of projectile is increased until the target is perforated. The term “V50” designates the velocity at which half of a certain type of projectile fired at the target will penetrate the target and half will not.

### Ceramic Member

The ceramic member 510 can be made from any suitable ceramic such as, for example, carbide, boron carbide, titanium carbide, tungsten carbide, zirconia toughened alumina, and high-density aluminum oxide. Suitable ceramic materials are commercially available from CoorsTek, Inc., located in Golden, Colo. and are sold under the trademarks CERASHIELD and CERCOM. Other suitable ceramic materials are commercially available from CeramTec GmbH, located in Germany. The thickness of the ceramic member 510 and the specific type of ceramic can be selected based on a desired level of ballistic performance according to, for example, the NIJ standards described herein. In some examples, the thickness of the ceramic member 510 can be 0.25-0.75, 0.5-1.0, 0.75-1.25, 1.0-1.5 inches.

The foregoing description has been presented for purposes of illustration and description. It is not intended to be exhaustive or to limit the claims to the embodiments disclosed. Other modifications and variations may be possible in view of the above teachings. The embodiments were chosen and described to explain the principles of the invention and its practical application to enable others skilled in the art to best utilize the invention in various embodiments and various modifications as are suited to the particular use contemplated. It is intended that the claims be construed to include other alternative embodiments of the invention except insofar as limited by the prior art. As used herein, the term “about” means plus or minus five percent of a value it precedes. Accordingly, the phrase “about 325 degrees F.” should be interpreted as a range of temperatures extending from 308.8 to 341.3 degrees F.

What is claimed is:

1. A ballistic resistant apparatus comprising:
a ceramic member defined by an outer surface; and
a composite layer adjacent to the outer surface of the ceramic member, the composite layer encasing the ceramic member and providing a compressive force against the outer surface of the ceramic member, the composite layer comprising a reinforcing layer impregnated with a matrix material, the composite layer serving as a durable, protective shell encasing the ceramic member.

2. The ballistic resistant apparatus of claim 1, wherein the reinforcing layer comprises a woven or nonwoven fabric comprising carbon, glass, aramid, para-aramid, meta-aramid, polyolefin, or thermoplastic polyethylene fibers

3. The ballistic resistant apparatus of claim 1, wherein the matrix material comprises a thermoset resin comprising epoxy resin, vinyl-ester resin, or polyester resin.

4. The ballistic resistant apparatus of claim 1, wherein the reinforcing layer comprises:
a first sheet of reinforcing fabric; and
a second sheet of reinforcing fabric, wherein the first sheet of reinforcing fabric is wrapped around the outer surface of the ceramic member, and wherein the second sheet of reinforcing fabric is wrapped around an outer surface of the first sheet of reinforcing fiber.

5. The ballistic resistant apparatus of claim 1, wherein the ceramic member comprises silicon carbide, boron carbide, titanium carbide, tungsten carbide, zirconia toughened alumina, or high-density aluminum oxide.

6. The ballistic resistant apparatus of claim 1, further comprising a film adhesive layer positioned between the outer surface of the ceramic member and an inner surface of the composite layer, the film adhesive layer configured to bond the inner surface of the composite layer to the outer surface of the ceramic member.

7. The ballistic resistant apparatus of claim 6, wherein the film adhesive layer comprises polyethylene, polypropylene, ethylene, copolyester, copolyamide, or thermoplastic polyurethane, and wherein the film adhesive layer is formed by flat film extrusion, blown film extrusion, or slit film extrusion process.

8. The ballistic resistant apparatus of claim 1, further comprising a stack of two or more ballistic sheets positioned between the outer surface of the ceramic member and the inner surface of the composite layer.

9. The ballistic resistant apparatus of claim 1, further comprising a waterproof protective cover encasing the composite layer.

10. A method of manufacturing a ballistic resistant apparatus, the method comprising:
providing a ceramic member defined by an outer surface;
wrapping a first sheet of preimpregnated carbon fiber fabric around the outer surface of the ceramic member;
wrapping a second sheet of preimpregnated carbon fiber fabric around an outer surface of the first sheet of preimpregnated carbon fiber fabric, wherein the first and second sheets of preimpregnated carbon fiber fabric are impregnated with a resin that is uncured;
placing the ceramic member wrapped in the first and second sheets of preimpregnated carbon fiber into a vacuum bag, sealing the vacuum bag, and applying a vacuum to the vacuum bag; and
placing the vacuum bag containing the ceramic member wrapped in the first and second sheets of preimpregnated carbon fiber into a pressure vessel and increasing the pressure in the pressure vessel to about 14.7-145, 25-125, 50-100, or 75-100 psi for a first predetermined duration.

11. The method of claim 10, wherein the first predetermined duration is about 1-240, 15-120, 30-90, or 45-60 minutes.

12. The method of claim 10, further comprising: maintaining a temperature in the pressure vessel of about 100-150, 150-200, 200-250, 250-300, or 300-500 degrees Fahrenheit to cure the resin in the first and second sheets of preimpregnated carbon fiber fabric for a second predetermined duration.

13. The method of claim 10, wherein the second predetermined duration is about 1-240, 15-120, 30-90, or 45-60 minutes.

14. The method of claim 10, wherein the pressure vessel is an autoclave or hydroclave.

15. The method of claim 10, further comprising inserting a film adhesive layer between the outer surface of the ceramic member and the inner surface of the first sheet of preimpregnated carbon fiber fabric before wrapping the first sheet of preimpregnated carbon fiber fabric around the ceramic member, wherein the film adhesive layer comprises polyethylene, polypropylene, ethylene, copolyester, copolyamide, or thermoplastic polyurethane.

16. A ballistic resistant apparatus for a vehicle, dwelling, or carrier vest, the ballistic resistant apparatus comprising:
a ceramic member defined by an outer surface, wherein the ceramic member comprises silicon carbide, boron carbide, titanium carbide, tungsten carbide, zirconia toughened alumina, or high-density aluminum oxide; and
a composite layer encasing the ceramic member and providing a compressive force against the outer surface of the ceramic member, the composite layer comprising a reinforcing layer impregnated with a matrix material, wherein the matrix material is a thermoset resin that has been cured at a pressure below 10 atmospheres to harden to form, in combination with the reinforcing layer, the composite layer.

17. The ballistic resistant apparatus of claim 16, wherein the thermoset resin was cured at a pressure of about 14.7-145, 25-125, 50-100, or 75-100 psi to harden to form the composite layer.

18. The ballistic resistant apparatus of claim 16, wherein the thermoset resin was cured while the ballistic resistant apparatus was sealed within an evacuated vacuum bag.

19. The ballistic resistant apparatus of claim 16, wherein the thermoset resin was cured while the ballistic resistant apparatus was sealed within a vacuum bag and positioned inside an autoclave.

20. The ballistic resistant apparatus of claim 16, wherein the thermoset resin was cured while the ballistic resistant apparatus was sealed within a vacuum bag, positioned inside an autoclave, and heated to a temperature of about 100-150, 150-200, 200-250, 250-300, or 300-500 degrees Fahrenheit.
